(19) United States
(12) Patent Application Publication
(10) Pub. No.: US 2019/0095788 A1
(43) Pub. Date: Mar. 28, 2019

(54) SUPERVISED EXPLICIT SEMANTIC ANALYSIS

(71) Applicant: Microsoft Technology Licensing, LLC, Redmond, WA (US)

(72) Inventors: Majid Yazdani, Dublin (IE); Daria Bogdanova, Dublin (IE)

(21) Appl. No.: 15/717,612

(22) Filed: Sep. 27, 2017

(51) Int. Cl. G06N 3/08; G06F 17/30

(52) U.S. Cl. CPC G06N 3/08; G06F 17/30011

(57) ABSTRACT

Method and system to use supervised explicit semantic analysis in modeling semantics of a document, referred to as Supervised Explicit Semantic Analysis (SESA or Supervised ESA) is described. The SESA model includes an encoder that maps an object to a latent space, a knowledge base that provides the explicit categories, a projector that projects the latent representations to the explicit space, and similarity scorer that estimates the similarity between objects in the explicit space. In the context of an on-line social network system, the SESA model can be used beneficially to determine similarity between member profiles and electronic job postings with respect to skill entities stored in the on-line social network system.

### TECHNICAL FIELD

This application relates to the technical fields of software and/or hardware technology and, in one example embodiment, to system and method to use supervised explicit semantic analysis in modeling semantics of a document.

### BACKGROUND

An on-line social network may be viewed as a platform to connect people in virtual space, where registered members establish and document networks of people. Each registered member of an on-line social network may be represented by a member profile, which, in turn, may he represented by one or more web pages, a structured representation of the member's information in XML (Extensible Markup Language), JSON (lavaScript Object Notation) or similar format. A member's profile web page of a social networking web site may emphasize employment history and education of the associated member. An on-line social network system also may be configured to facilitate job search for social network members and talent search for employers by evaluating potential matches of requirements presented in posted job descriptions with professional qualifications represented by members in their respective member profiles.

### BRIEF DESCRIPTION OF DRAWINGS

Embodiments of the present invention are illustrated by way of example and not limitation in the figures of the accompanying drawings, in which like reference numbers indicate similar elements and in which:

FIG. 1 is a diagrammatic representation of a network environment within which an example method and system to use supervised explicit semantic analysis in modeling semantics of a document may be implemented;

FIG. 2 is block diagram of a system to use supervised explicit semantic analysis in modeling semantics of a document, in accordance with one example embodiment;

FIG. 3 is a flow chart of a method to use supervised explicit semantic analysis in modeling semantics of a document, in accordance with an example embodiment; and

FIG. 4 is a diagrammatic representation of an example machine in the form of a computer system within which a set of instructions, for causing the machine to perform any one or more of the methodologies discussed herein, may be executed.

### DETAILED DESCRIPTION

A method and system to use supervised explicit semantic analysis in modeling semantics of a document in an on-line social network is described. In the following description, for purposes of explanation, numerous specific details are set forth in order to provide a thorough understanding of an embodiment of the present invention. It will be evident, however, to one skilled in the art that the present invention may be practiced without these specific details.

As used herein, the term “or” may be construed in either an inclusive or exclusive sense. Similarly, the term “exemplary” is merely to mean an example of something or an exemplar and not necessarily a preferred or ideal means of accomplishing a goal. Additionally, although various exemplary embodiments discussed below may utilize Java-based servers and related environments, the embodiments are given merely for clarity in disclosure. Thus, any type of server environment, including various system architectures, may employ various embodiments of the application-centric resources system and method described herein and is considered as being within a scope of the present invention.

For the purposes of this description the phrase “an on-line social networking application” may be referred to as and used interchangeably with the phrase “an on-line social network” or merely “a social network.” It will also be noted that an on-line social network may be any type of an on-line social network, such as, a professional network, an interest-based network, or any on-line networking system that permits users to join as registered members. For the purposes of this description, registered members of an on-line social network may be referred to as simply members.

Each member of an on-line social network is represented by a member profile (also referred to as a profile of a member or simply a profile). A member profile may be associated with social links that indicate the member's connection to other members of the social network. A member profile may also include or be associated with comments or recommendations from other members of the on-line social network, with links to other network resources, such as, e.g., publications, etc. As mentioned above, an on-line social networking system may be designed to allow registered members to establish and document networks of people they know and trust professionally. Any two members of a social network may indicate their mutual willingness to he “connected” in the context of the social network, in that they can view each other's profiles, provide recommendations and endorsements for each other and otherwise be in touch via the social network.

The profile information of a social network member may include personal information such as, e.g., the name of the member, current and previous geographic location of the member, current and previous employment information of the member, information related to education of the member, information about professional accomplishments of the member, publications, patents, etc. The profile information of a social network member may also include information about the member's professional skills, such as, e.g., “product management, ” “patent prosecution,” “image processing,” etc.).

The profile of a member may also include information about the member's current and past employment, such as company identifications, professional titles held by the associated member at the respective companies, as well as the member's dates of employment at those companies. A professional title that may be present in a member profile and indicate a professional position of the member during a particular period of employment may be referred to as a title string. Thus, a title string that appears in a member profile may be associated with a particular company and also with a period of time during which the member held, at that company, a particular position.

An on-line social network system also maintains information about various companies, as well as so-called job postings. A job posting, for the purposes of this description is an electronically stored entity that includes information that an employer may post with respect to a job opening. The information in a job posting may include, e.g., the industry, job position, required and/or desirable skills, geographic location of the job, the name of a company, etc. The on-line social network system includes or is in communication with a so-called job relevance system. A job relevance system is configured to match member profiles with job postings, so that those job postings that have been identified as potentially being of interest to a member represented by a particular member profile are presented to the member on a display device for viewing. In one embodiment, the job postings that are identified as of potential interest to a member are presented to the member in order of relevance with respect to the associated member profile. The task of determining relevance with respect to a pair comprising a job posting and a member profile (Job-Profile relevance) can be addressed using machine learning techniques.

In creating a machine learning system, the task of feature selection can be automated by creating numerical vectors that reflect the semantics of the respective objects. These vectors (e.g., feature vectors representing respective member profiles and job postings) can then be used as input into machine learning algorithms. Various methods for obtaining vector representations of words and documents rely on the distributional hypothesis which states that words in similar contexts have similar meanings.

Methodologies for feature selection (also referred to as representation learning) include those that are supervised, where features are learned using labeled input data, and those that are unsupervised, where features are learned using unlabeled input data.

An example of an unsupervised representation learning method is Latent Semantic Analysis (LSA), which starts with a high-dimensional term-frequency matrix and maps it to a latent low-dimensional space by applying Singular Value Decomposition (SVD). Other unsupervised methods include a probabilistic version of latent semantic analysis and Latent Dirichlet Allocation, as well as predictive methods for modeling semantics. Predictive methods for modeling semantics, such as, e.g., the Continuous Bag of Words and the Skip-gram models, treat the task of mapping a word to a meaningful vector as a predictive machine learning task instead of relying on word counts. Notably, the dimensions of these latent space models have no clear meaning, resulting sometimes in hard to interpret results and difficult to introspect machine learned systems. However, the interpretability of the machine learning methods may be of benefit, as many applications concern not only about the prediction being correct but also about the reasons that decision has been made. This issue is being addressed by so-called Explicit Semantic Analysis (ESA) that represents words as vectors in which each dimension corresponds to a knowledge base entity, e.g., a Wikipedia article. An ESA system builds an inverted index of word frequencies in Wikipedia pages, each word being represented as a vector of the size of Wikipedia articles, such that the weight of each dimension is the word frequency in the corresponding Wikipedia article. To get a representation of a document, one can average the representations of all the words in that document. These unsupervised methods provide a generic representation of the objects, but usually need to be optimized for a specific task. Many supervised representation learning models for performing relevance, ranking and information retrieval tasks, such as, Polynomial Semantic indexing (PSI) that is trained for ranking and Deep Semantic Similarity Model (DSSM), are used in information retrieval and web search ranking but they too generate results that are not interpretable in that the dimensions of these models have no clear meaning.

In one example embodiment, a model for representation learning is described. This model is referred to as Supervised Explicit Semantic Analysis (SESA or Supervised ESA). It is trained in a supervised manner and at the same time it produces output that is interpretable. SESA learns to compare two objects by representing them in an explicit space and produce ranking results, where every dimension corresponds to a concept from a knowledge base. In the context of the on-line social network system this model uses skills taxonomy for defining explicit space and is applied to the task of Job-Profile relevance.

The SESA model, which is trained using labeled data and a loss function, includes the following components: (1) encoder that maps an object to a latent space, (2) knowledge base that provides the explicit categories, (3) projector that projects the latent representations to the explicit space, and (4) similarity scorer that estimates the similarity between objects in the explicit space. Every profile and job are encoded to this set of skills and their similarity is calculated in this space. The encoder for embedding text input into a latent space uses RNNs Recurrent Neural Networks, in some embodiments, specifically, Long Short Term Memory RNNs (LTSM).

The input to the encoder (also referred to as the LSTM encoder of merely LSTM) is a sequence of vectors representing words. The words can be first encoded as one-hot vectors, and then a lookup matrix is used to get their respective dense vector representations. This matrix can be initialized randomly or with pretrained word vectors. One way to pretrain word embeddings is using the skip gram model-word2vec models that are trained to reconstruct linguistic contexts of words. The output of the encoder is a fixed-sized vector representation of the input. The output of the encoder (the latent vector), that is used by the SESA model as input to the projector that projects the latent representations to the explicit space, can be either the output of the last LSTM cell (f_{LSTM}_{_{encoder}}(x)=hₙ) or an average of the LSTM outputs

$$( {f}_{{LSTM}_{encoder}} ( x ) = \frac{{Σ}_{n}^{1} {h}_{n}}{n} ) ,$$

where x is the input sequence, n is the length of x, and h is a current state (hidden state) calculated by the LSTM. A current state h calculated by the LSTM may be produced using hyperbolic tangent (tan h) or rectified linear function.

The projector projects the resulting latent representation into the explicit semantic space. A linear projector can be used to map the latent vector into the explicit semantic space. A knowledge base provides the explicit categories that will serve as dimensions of the explicit semantic space is the set of skills in a dictionary of skills maintained by the on-line social network system. The dictionary of skills stores words and phrases that were entered by members of the on-line social network system to make their professional skills discernable from their respective member profiles. The words and phrases intended to represent professional skills of members are associated with a particular type offeld in the member profiles and are identified as being of a particular entity type-skill entity. The projector is configured to represent member profiles and job postings in this space.

Let's assume shows an object's features; then the latent (implicit) representation of x is produced by the encoder can be expressed by Equation 1 below.

eᵢₘₚₗ=f_{enc}(x) Equation 1

The projector maps the latent representation x to the explicit space, as expressed by Equation 2 below.

eₑₓₚₗ=fₚᵣₒⱼ(eᵢₘₚₗ₎ Equation 2

The mapping of the latent representation x to the explicit space using a linear projector is expressed by Equation 3 below.

eₑₓₚₗW*eᵢₘₚₗ_{_{x′}} Equation 3

where W is a m×n weight matrix, used to convert the latent representation of n object into the explicit representation, where in is the dimension of the encoder's output and a is the number of explicit categories.

The mattix W is first initialized randomly and then is optimized in a supervised fashion using a aadient-based method, in some embodiments, W is trained on the job-profile data, e.g., what jobs presented to members were clicked/not clicked. The job-profile data is also used to train the parameters of LSTM.

The similarity scorer compares two vectors representing two objects in the explicit space to estimate similarity between the two objects in the explicit semantic space. In the embodiments, where the burden of learning in the SESA model lies on the encoder and the projector, the similarity scorer may employ simple scoring methodologies, such as, e.g., cosine similarity, dot product or a Euclidean distance. In some embodiments, a similarity scorer may be implemented to employ trainable similarity functions. The similarity score produced by the similarity scorer with respect to a member profile and a job posting can be used as input to a relevance model provided with the on-line social network system to calculate probability of a member represented by the member profile applying for a job represented by the job posting.

In some embodiments, e.g., in the context of processing the task of predicting relevance of a job posting with respect to a member profile in the on-line social network system, the SESA model uses a dictionary of skills maintained by the on-line social network system as the knowledge base. A member profile, for the purposes of predicting relevance of a job posting with respect to that member profile, can be represented as a vector of skills that are found in that profile by retrieving entities of the skills category from the member profile. A job posting, on the other hand, is not necessarily provided in a structured format, in that the skills required for the advertised job may not always be identified or tagged as being of a particular entity type-skill entity. For example, a job posting in the on-line social network system may appear as shown below.
“We are looking for talented Data Engineers with strong programming skills and know ledge of neural networks capable of rapid application development within an Agile environment”

This job position would likely require software engineering, machine learning, deep learning and Agile methodologies and would not require budget control or online merchandising. A person possessing most or all of the required skills is likely to be a good match for this position, and vice versa, a person that does not possess the skills required for a job, is not likely to be a good match. SESA model uses the encoder to map the job description to its latent representation, as described above, and then uses the projector to map it to the explicit space of skills stored in the skills dictionary. As the members' profiles are already tagged with skills, the SESA model extracts the skills from the member profile to generate an explicit representation of the member profile that is then compared with the explicit representation of the job posting using the similarity scorer, as described above.

Parameters of the SESA model are trained using labled data and a loss function, such as, e.g., mean squared error (MSE) loss function. For example, the training data may be automatically collected in the on-line social network system by monitoring interactions of members with jobs presented to then as being potentially of interest and noting whether the presentation of a job to a member resulted in that member applying for associated job position. The training data may be in the form of pairs comprising a job posting and a member profile (job-profile pairs), where a pair is labeled as positive if the person has applied for a job, and as negative if the person has viewed the job but did not apply. A subset of all skills that are present in the skills dictionary stored and maintained in the on-line social network system may be used as the skills taxonomy. The SESA model can be trained using logistic regression and gradient boosting baselines using common meta-information as features. For example, the features can be divided into three categories: (1) job-only features: e.g., location, company size, seniority and required skills; (2) profile-only features: e.g., location, current company, current industry, gender, seniority; and (3) job-profile similaiity features: e.g., cosine similarity and Jaccard similarity between tf-idf (term frequency-inverse document frequency) representation of all job information and all profile information. A job description. (the content of a job posting) can be mapped to a set of skills required for this job, using an encoder, which can be an LSTM encoder, as explained above.

The word embeddings in the LSTM encoder are pre-trained using the skip-gram model on a corpus of documents, which may include Wikipedia articles, as well as job postings and news articles available m the on-line social network system. In one embodiment, the network can be trained with stochastic gradient descent by minimizing mean squared error on the training set.

Training the SESA model for job-profile relevance task provides further beneficial features: skills embeddings and the ability to tag job postings (or any electronic document that has been processed by the SESA model) with the associated skills. With respect to skills embeddings, the weight matrix W (see Equation 3) can be viewed as the matrix of skills embeddings. In these embeddings, the skills which behave similarly in the job-profile matching task are closer vectors. This approach provides embeddings that are different from those provided by other unsupervised word embeddings since these embeddings are optimized for this particular supervised task.

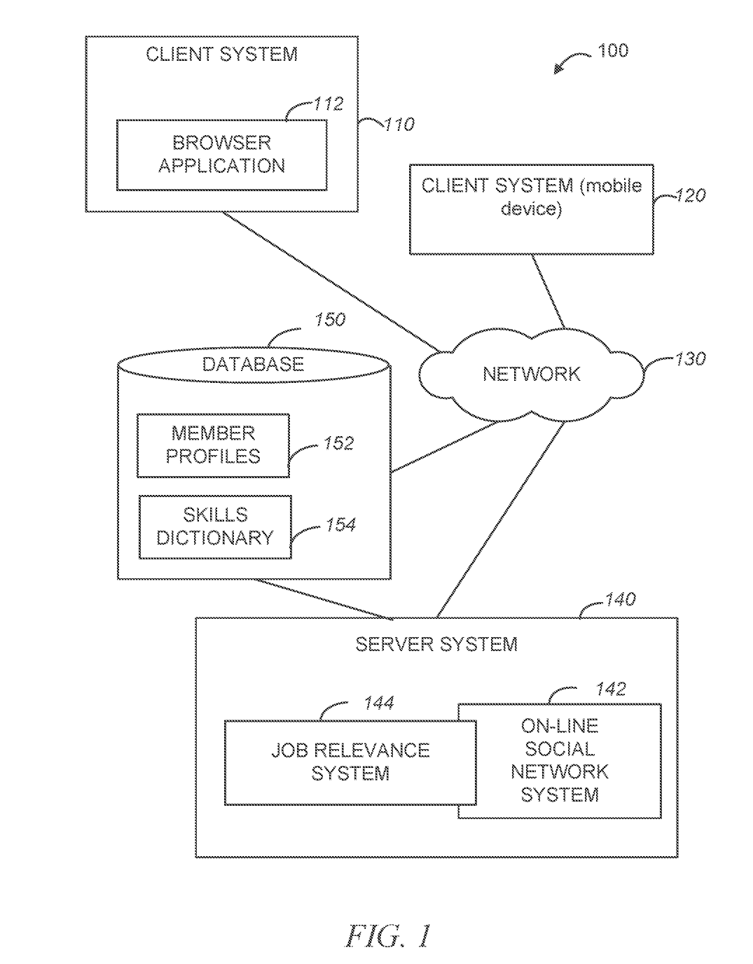

In some embodiments a so-called tagger may be provided. The output of the tagger is a real vector in the space of skills, in which if a relevant skill is associated with a positive value and a skill that is irrelevant is associated with a negative value. Example method and system to use supervised explicit semantic analysis in modeling semantics of a document may be implemented in the context of a network environment 100 illustrated in FIG. 1.

As shown in FIG. 1, the network environment 100 may include client systems 110 and 120 and a server system 140. The client system 120 may be a mobile device, such as, e.g., a mobile phone or a tablet. The server system 140, in one example embodiment, may host an on-line social network system 142. As explained above, each member of an on-line social network is represented by a member profile that contains personal and professional information about the member and that may be associated with social links that indicate the member's connection to other member profiles in the on-line social network. Member profiles and related information may be stored in a database 150 as member profiles 152. The database 150 also stores a skills dictionary 154.

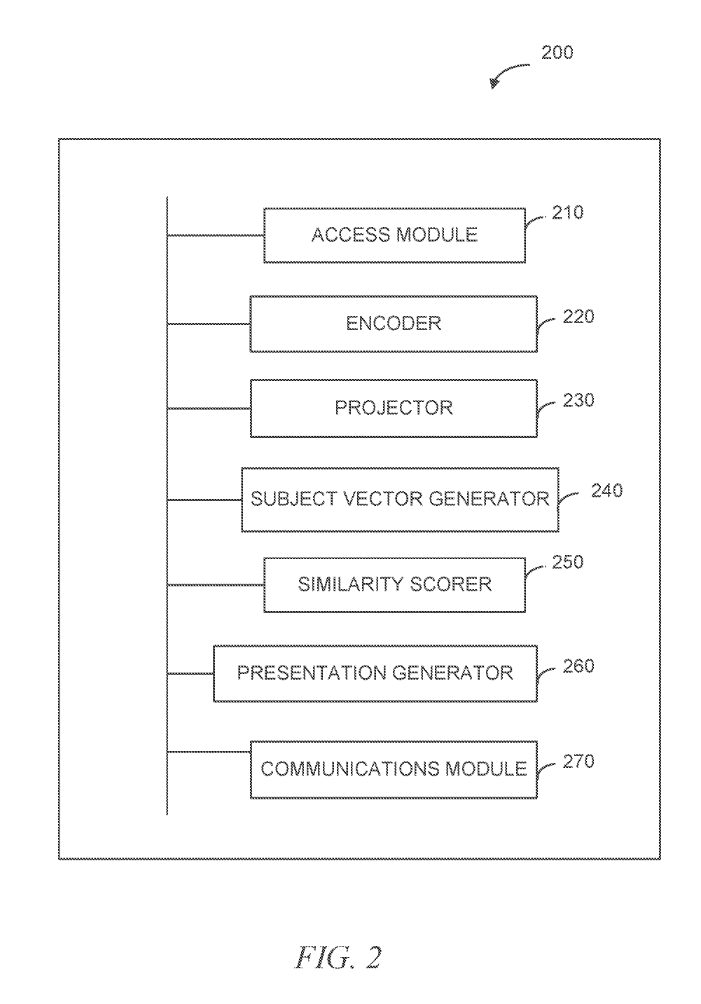

The client systems 110 and 120 may be capable of accessing the server system 140 via a communications network 130, utilizing, e.g., a browser application 112 executing on the client system 110, or a mobile application executing on the client system 120. The communications network 130 may be a public network (e.g., the Internet, a mobile communication network, or any other network capable of communicating digital data). As shown in FIG. 1, the server system 140 also hosts a job relevance system 144 that utilizes the SESA model described above to calculate similarity between a member profile and a job posting in order to determine whether the job posting should be recommended to an associated member as being potentially of interest to the member. An example job relevance system 144 is illustrated in FIG. 2.

FIG. 2 is a block diagram of a system 200 to use supervised explicit semantic analysis in modeling semantics of a document, in accordance with one example embodiment. The system 200, in some embodiments, corresponds to the job relevance system 144. As shown in FIG. 2, the system 200 includes an access module 210, an encoder 220, a projector 230, a subject vector generator 240, a similarity scorer 150, and a presentation generator 260.

The access module 210 is configured to access electronic documents in an on-line social network system that maintains profiles representing respective members. The electronic document may be job postings and may be unstructured documents. The encoder 220 is configured to generate a latent vector representing the electronic document, using a neural network encoder, as explained in more detail above. The neural network may be, e.g., a recurrent neural network (RNN) or a feedforward neural network.

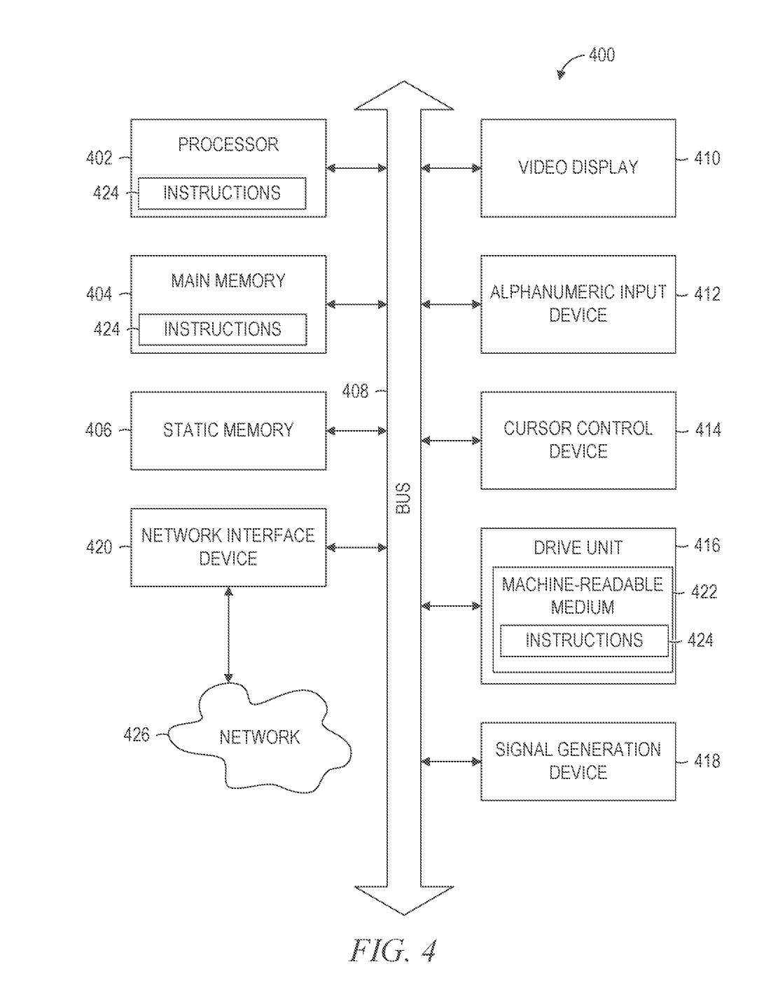

The projector 230 is configured to produce a document vector based on the lavent, vector, e.g., using Equation 3 above. The document vector is an explicit vector representation of the electronic document, where each dimension of the document vector corresponds to an explicit category from a set of explicit categories. In some embodiments, the projector 230 is a linear projector—a weight matrix having a first dimension corresponding to the set of explicit categories and a second dimension corresponding to values in the latent vector. The producing of the document vector comprises multiplying weight matrix by the latent vector. In the context of an on-line social system, the set of explicit categories is a set of skill entities, e.g., as those stored in the skills dictionary 154 of FIG. 4 maintained by the on-line social network system 142 of FIG. 1. The weight matrix and the neural network encoder are trained on a labelled set using gradient descent. In some embodiments, an item from the labelled set comprises a reference to a given electronic document, a reference to a given member profile, and a label representing an action of a member represented by a given member profile with respect to the given electronic document.

The subject vector generator 240 is configured to generate a subject vector, the subject vector being an explicit vector representation of a subject member profile (from the profiles maintained by the on-line social network system 142). The subject vector comprises respective identifications of explicit categories, from the explicit categories, included in the subject member profile

The similarity scorer 150 is configured to calculate a similarity value representing similarity between the document vector and the subject vector. The presentation generator 160 is configured to determine, using the similarity value, that a personalized user interface (UI) for a member represented by the subject member profile is to include a reference to the electronic document, and to generate a personalized user interface (UI) for a member represented by the subject member profile, the personalized UI including reference to the electronic document. The system 200, in some embodiments, also includes a communications module to communicate the personalized UI to a client computer associated with the member and a tagger.

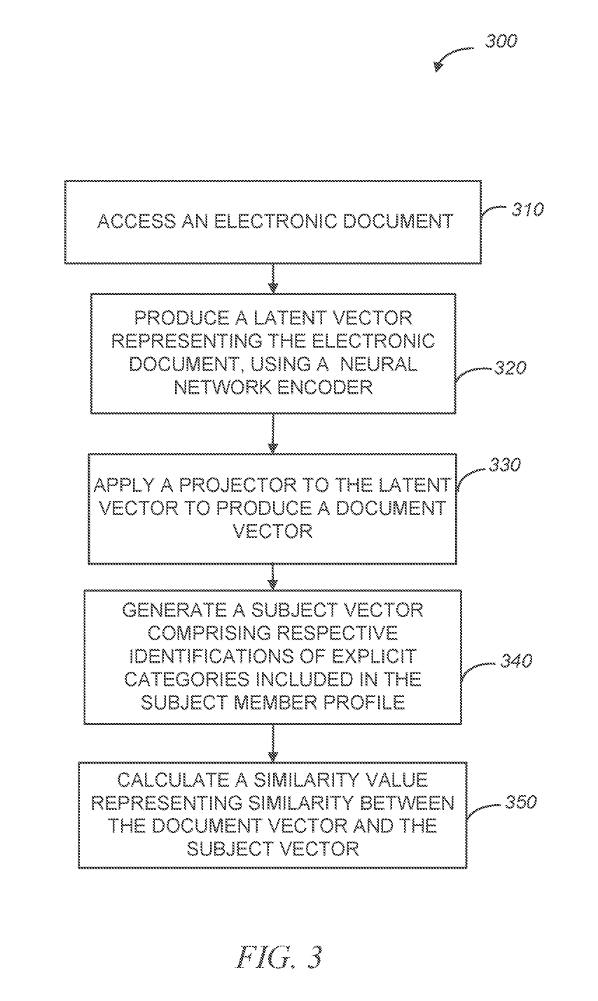

The tagger is configured to select a subset of explicit categories from the set of skill entities based on values in a given document vector and associate the subset of explicit categories with the electronic document represented by the document vector. This association can be stored for subsequent use, e.g., by the on-line social network system. The presentation generator 160 may be configured to use the associated subset of explicit categories in determining whether the electronic document is likely to be of interest to a member represented by a given member profile, based on comparing the subset of explicit categories associated with the electronic document and explicit categories included in the given member profile. Some operations performed by the system 200 may be described with reference to FIG. 3.

FIG. 3 is a flow chart of a method 300 to use supervised explicit semantic analysis in modeling semantics of a document, according to one example embodiment. The method 300 may be performed by processing logic that may comprise hardware (e.g., dedicated logic, programmable logic, microcode, etc.), software (such as run on a general purpose computer system or a dedicated machine), or a combination of both. In one example embodiment, the processing logic resides at the server system 140 of FIG. 1 and, specifically, at the system 200 shown in FIG. 2.

As shown in FIG. 3, the method 300 commences at operation 310, when the access module 210 access an electronic document in an on-line social network system that maintains profiles representing respective members. The encoder 220 generates a latent vector representing the electronic document, using a neural network encoder, at operation 320. At operation 330, based on the latent vector, the projector 230 produces a document vector, which is an explicit vector representation of the electronic document, where each dimension of the document vector corresponds to an explicit category from a set of explicit categories. As explained above, the projector 230 may be a linear projector—a weight matrix having a first dimension corresponding to the set of explicit categories and a second dimension corresponding to values in the latent vector. The subject vector generator 240 generates a subject vector, which is an explicit vector representation of a subject member profile at operation 340. The similarity scorer 150 calculates a similarity value representing similarity between the document vector and the subject vector at operation 350.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may he distributed across a number of locations.

FIG. 4 is a diagrammatic representation of a machine in the example form of a computer system 400 within which a set of instructions, for causing the machine to perform any one or more of the methodologies discussed herein, may be executed. In alternative embodiments, the machine operates as a stand-alone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to he taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 400 includes a processor 402 (e.g., a central processing unit (CPU), a graphics processing unit (GPU) or both), a main memory 404 and a static memory 406, which communicate with each other via a bus 404. The computer system 400 may further include a video display unit 410 liquid crystal display (LCD) or a cathode ray tube (CRT)). The computer system 400 also includes an alpha-numeric input device 412 (e.g., a keyboard), a user interface (UI) navigation device 414 (e.g., a cursor control device), a disk drive unit 416, a signal generation device 418 (e.g., a speaker) and a network interface device 420.

The disk drive unit 416 includes a machine-readable medium 422 on which is stored one or more sets of instructions and data structures (e.g., software 424) embodying or utilized by any one or more of the methodologies or functions described herein. The software 424 may also reside, completely or at least partially, within the main memory 404 and/or within the processor 402 during execution thereof by the computer system 400, with the main memory 404 and the processor 402 also constituting machine-readable media.

The software 424 may further be transmitted or received over a network 426 via the network interface device 420 utilizing any one of a number of well-known transfer protocols (e.g., Hyper Text Transfer Protocol (HTTP)).

While the machine-readable medium 422 is shown in an example embodiment to be a single medium, the term “machine-readable medium” should be taken to include a single medium or multiple media (e.g., a centralized or distributed database, and/or associated caches and servers) that store the one or more sets of instructions. The term “machine -readable medium” shall also be taken to include any medium that is capable of storing and encoding a set of instructions for execution by the machine and that cause the machine to perform any one or more of the methodologies of embodiments of the present invention, or that is capable of storing and encoding data structures utilized by or associated with such a set of instructions. The term “machine-readable medium” shall accordingly be taken to include, but not be limited to, solid-state memories, optical and magnetic media. Such media may also include, without limitation, hard disks, floppy disks, flash memory cards, digital video disks, random access memory (RAMs), read only memory (ROMs), and the like.

The embodiments described herein may be implemented in an operating environment comprising software installed on a computer, in hardware, or in a combination of software and hardware. Such embodiments of the inventive subject matter may be referred to herein, individually or collectively, by the term “invention” merely for convenience and without intending to voluntarily limit the scope of this application to any single invention or inventive concept if more than one is, in fact, disclosed.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

Thus, method and system to use supervised explicit semantic analysis in modeling semantics of a document have been described. While the techniques for formulating a search query have been described with reference to searches in the context of an on-line social network system, the method and system to use supervised explicit semantic analysis in modeling semantics of a document may be used beneficially in any context where electronic search results are being requested and retrieved. Although embodiments have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense.

1. A computer-implemented method comprising:
in an on-line social network system that maintains profiles representing respective members of the on-line social network system, accessing an electronic document;
using at least one processor, generating a latent vector representing the electronic document, using a neural network encoder;
applying a projector to the latent vector, producing a document vector, the document vector being an explicit rector representation of the electronic document, where each dimension of the document vector corresponds to an explicit category from a set of explicit categories;
generating a subject vector, the subject vector being an explicit vector representation of a subject member profile from the profiles, the subject vector comprising respective identifications of explicit categories, from the explicit categories, included in the subject member profile;
calculating a similarity value representing similarity between the document vector and the subject vector;
determining, using the similarity value, if a personalized user interface (UI) for a member represented by the subject member profile is to include a reference to the electronic document; and
generating a personalized user interface (UI) for a member represented by the subject member profile, the personalized UI including reference to the electronic document.

2. The method of claim 1, wherein the projector is a linear projector comprising a weight matrix having a first dimension corresponding to the set of explicit categories and a second dimension corresponding to values in the latent vector.

3. The method of claim 2, wherein the producing of the document vector comprises multiplying weight matrix by the latent vector.

4. The method of claim 2, wherein the set of explicit categories is a set of skill entities maintained by the on-line social network system.

5. The method of claim 2, wherein the weight matrix and the neural network encoder are trained on a labelled set using gradient descent.

6. The method of claim 5, wherein an item from the labeled set comprises a reference to a given electronic document, a reference to a given member profile, and a label representing an action of a member represented by a given member profile with respect to the given electronic document.

7. The method of claim 1, comprising:
based on values in the document vector, selecting a subset of skills from the set of skill entities; and
associating the subset of skills with the electronic document in the on-line social network system.

8. The method of claim 4, comprising, for a further member profile and the electronic document, determining a probability of the electronic document being of interest to a member represented by the further member profile, based on comparing the subset of skills associated with the electronic document and skills included in the further member profile.

9. The method of claim 1, wherein the neural network is a recurrent neural network.

10. The method of claim 1, wherein the neural network is a feedforward neural network.

11. A computer-implemented system comprising:
in an online social network system that maintains profiles representing respective members of the on-line social network system, an access module, implemented using at least one processor, to access an electronic document;
a neural network encoder, implemented using at least one processor, to produce a latent vector representing the electronic document;
a projector, implemented using at least one processor, to produce a document vector based on the latent vector, the document vector being an explicit vector representation of the electronic document, where each dimension of the document vector corresponds to an explicit category from a set of explicit categories;
a subject vector generator, implemented using at least one processor, to generate a subject vector, the subject vector being an explicit vector representation of a subject member profile from the profiles, the subject vector comprising respective identifications of explicit categories, from the explicit categories, included in the subject member profile;
a similarity scorer, implemented using at least one processor, to generate a similarity value representing similarity between the document vector and the subject vector; and
a presentation generator, implemented using at least one processor, to:
determine, using the similarity value, that a personalized user interface (UI) for a member represented by the subject member profile is to include a reference to the electronic document, and
generate a personalized user interface (UI) for a member represented by the subject member profile, the personalized UI including reference to the electronic document.

12. The system of claim 11, wherein the projector is a linear projector comprising a weight matrix having a first dimension corresponding to the set of explicit categories and a second dimension corresponding to values in the latent vector.

13. The system of claim 12, wherein the producing of the document vector comprises multiplying weight matrix by the latent vector.

14. The system of claim 12, wherein the set of explicit categories is a set of skill entities maintained by the on-line social network system.

15. The system of claim 12, wherein the weight matrix and the neural network encoder are trained on a labelled set using gradient descent.

16. The system of claim 15, wherein an item from the labeled set comprises a reference to a given electronic document a reference to a given member profile, and a label representing an action of a member represented by a given member profile with respect to the given electronic document.

17. The system of claim 11, comprising a tagger, implemented using at least one processor, to:
based on values in the document vector, select a subset of skills from the set of skill entities; and
associate the subset of skills with the electronic document in the on-line social network system.

18. The system of claim 14, wherein the presentation generator is to, for a further member profile and the electronic document, determine a probability of the electronic document being of interest to a member represented by the further member profile, based on comparing the subset of skills associated with the electronic document and skills included in the further member profile.

19. The system of claim 11, wherein the neural network is a recurrent neural network.

20. A machine-readable non-transitory storage medium having instruction data executable by a machine to cause the machine to perform operations comprising:
in an on-line social network system that maintains profiles representing respective members of the on-line social network system, accessing an electronic document;
generating a latent vector representing the electronic document, using a neural network encoder;
applying a projector to the latent vector, producing a document vector, the document vector being an explicit vector representation of the electronic document, where each dimension of the document vector corresponds to an explicit category from a set of explicit categories;
generating a subject vector, the subject vector being an explicit vector representation of a subject member profile from the profiles, the subject vector comprising respective identifications of explicit categories, from the explicit categories, included in the subject member profile;
calculating a similarity value representing similarity between the document vector and the subject vector;
determining, using the similarity value, if a personalized user interface (UI) for a member represented by the subject member profile is to include a reference to the electronic document; and
generating a personalized user interface (UI) for a member represented by the subject member profile, the personalized UI including reference to the electronic document.
